(19) United States
(12) Patent Application Publication
(10) Pub. No.: US 2008/0092144 A1
(43) Pub. Date: Apr. 17, 2008

(54) INFORMATION PROCESSING APPARATUS AND CONTROL METHOD THEREOF, AND PROGRAM

(75) Inventor: Toshiyuki Nakazawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/870,514

(22) Filed: Oct. 11, 2007

(30) Foreign Application Priority Data
Oct. 17, 2006 (JP) 2006-283145

(51) Int. Cl. G06F 9/46

(52) U.S. Cl. 718/105

(57) ABSTRACT

Management statuses of devices are set. A management information group set by the set management statuses is classified into management information common to a plurality of target devices and management information common to each type of target device, and the classified management information is stored. For each class, the write process of the management information which belongs to that class in the target device is executed.

### BACKGROUND OF THE INVENTION

1. Field of the Invention

The present invention relates to an information processing apparatus which sets management statuses of a plurality of devices connected to a network, and makes write accesses of these management statuses to target devices, a control method thereof, and a program.

2. Description of the Related Art

In recent years, along with popularization of LAN (Local Area Network), a mode of connecting various devices to a LAN and using various devices from a computer connected to that LAN is prevalent. The use mode of devices connected to the network includes, e.g., sharing of a printer, transfer of an image scanned by a scanner, remote monitoring by a plurality of network cameras, and the like.

Upon using devices connected to the network, it is a common practice to set up an administrator who manages operations of these devices. The administrator performs management operations such as connections to the network, setting, monitoring of running states, and the like of respective devices. These management operations are done using management software which runs on a computer (management terminal) connected to the network.

For example, upon managing a printer connected to the network, the administrator must set management statuses including the installation location of a device, selection of a port used upon printing, and the like. The management statuses are set using management software installed on the management terminal via a network, or are set using a console of the printer main body or a Web page.

If different types of printers are to be managed, management statuses that can be set are different depending on the printer types, thus requiring the administrator to do complicated operations. If the number of printers to be managed is large, setting the management statuses in each individual printer creates a significant workload for the administrator.

Hence, as a method of simultaneously setting the management statuses for a plurality of types of printers or devices, a method of distinctly setting items which can be set for respective types of devices with different management statuses has been proposed (for example, see Pamphlet of International Publication No. WO 2001/073558).

With the aforementioned related art, the management method classifies management statuses into those common to target devices and those different for respective target device types upon setting the management statuses. Furthermore, the management method changes management information to be output to each target device according to the device type.

Therefore, the management method must specify the type of target device upon setting the management statuses and outputting the management information. For this reason, in order to cope with a new device, the internal configuration of the management method must often be changed. Also, processing becomes complicated when the management statuses that a device implements change according to equipment information of the device.

### SUMMARY OF THE INVENTION

The present invention has been made to solve the aforementioned problems, and has as its object to provide an information processing apparatus which can efficiently set the management statuses of devices on a network irrespective of device types, a control method thereof, and a program.

According to the first aspect of the present invention, an information management apparatus, which sets management statuses of a plurality of devices connected to a network, and writes the management statuses in a target device, comprising:

setting means for setting management statuses of a device;

storage means for classifying a management information group set by the management statuses set by the setting means into management information common to the plurality of target devices and management information common to each type of target device, and storing the classified management information; and

writing means for executing a write process of the management information, which belongs to each of classes stored in the storage means, in the target device.

In a preferred embodiment, the apparatus further comprises management status storage means for storing management statuses for each of the plurality of devices,

wherein the storage means classifies, with reference to the management statuses stored in the management status storage means, the management information group set by the management statuses set by the setting means into the management information common to the plurality of target devices and the management information common to the type of target device, and stores the classified management information.

In a preferred embodiment, the apparatus further comprises determination means for determining whether or not the write process by the writing means has succeeded; and

log information storage means for storing the determination result of the determination means as log information.

In a preferred embodiment, the writing means executes a write process of the management information common to the plurality of target devices of classes stored in the storage means, and then executes a write process of the management information common to each device type.

In a preferred embodiment, the writing means executes a write process of the management information in the target device using an SNMP.

In a preferred embodiment, the storage means classifies the management information group set by the management statuses set by the setting means into:

first indispensable management information that the plurality of target devices commonly and indispensably implement;

first optional management information that the plurality of target devices commonly and optionally implement;

second indispensable management information that a plurality of target devices of a specific type commonly and indispensably implement; and

second optional management information that the plurality of target devices of the specific type commonly and indispensably implement and

the storing means stores the classified management information.

In a preferred embodiment, the writing means executes a write process of corresponding optional information in the target device when a write process of the indispensable management information of the classes stored in the storage means in the target device has succeeded.

In a preferred embodiment, when the storage means assigns different management information to an identical management status depending on types of devices, and when a write process of management information corresponding to a device of an arbitrary type has failed, the writing means executes a write process of management information corresponding to a target device of a type different from that type in the target device.

According to the second aspect of the present invention, a method of controlling an information management apparatus, which sets management statuses of a plurality of devices connected to a network, and writes the management statuses in a target device, comprising:

a setting step of setting management statuses of a device;

a storage step of classifying a management information group set by the management statuses set in the setting step into management information common to the plurality of target devices and management information common to each type of target device, and storing the classified management information in a storage medium; and

a writing step of executing a write process of the management information, which belongs to each of classes stored in the storage medium in the storage step, in the target device.

According to the third aspect of the present invention, a program stored in a computer-readable medium to make a computer execute control of an information management apparatus, which sets management statuses of a plurality of devices connected to a network, and writes the management statuses in a target device, the program making the computer execute:

a setting step of setting management statuses of a device;

a storage step of classifying a management information group set by the management statuses set in the setting step into management information common to the plurality of target devices and management information common to each type of target device, and storing the classified management information in a storage medium; and

a writing step of executing a write process of the management information, which belongs to each of classes stored in the storage medium in the storage step, in the target device.

Further features of the present invention will become apparent from the following description of exemplary embodiments with reference to the attached drawings.

### BRIEF DESCRIPTION OF THE DRAWINGS

FIG. 1 is a diagram showing the arrangement of a device management system including that of connections between network devices and a computer according to the first embodiment of the present invention;

FIG. 2A is a block diagram showing the functional arrangement implemented by device management software according to the first embodiment of the present invention;

FIG. 2B is a block diagram showing the hardware arrangement of a computer according to the first embodiment of the present invention;

FIG. 3 is a diagram showing an example of acquisition and setting of management information from and in a network device using an SNMP according to the first embodiment of the present invention;

FIG. 4 is a diagram showing an example of acquisition and setting of management information from a network device using an SNMP according to the first embodiment of the present invention;

FIG. 5 shows a window example of a management status setting window according to the first embodiment of the present invention;

FIG. 6 shows the implementation states of the set management statuses in correspondence with respective device types according to the first embodiment of the present invention;

FIG. 7 is a flowchart showing the processing to be executed by the device management software according to the first embodiment of the present invention;

FIG. 8 is a chart for explaining exchange of SNMP packets upon setting management status setting values between the device management software and a printer according to the first embodiment of the present invention;

FIG. 9 shows the implementation states of set management statuses in target devices according to the second embodiment of the present invention;

FIG. 10 is a flowchart showing the processing to be executed by device management software according to the second embodiment of the present invention;

FIG. 11 is a chart for explaining exchange of SNMP packets upon setting management status setting values between the device management software and a printer according to the second embodiment of the present invention;

FIG. 12 shows the implementation states of set management statuses in target devices according to the third embodiment of the present invention;

FIG. 13 is a flowchart showing the processing to be executed by device management software according to the third embodiment of the present invention; and

FIG. 14 is a flowchart showing details of the processes in steps S1304 and S1307 according to the third embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

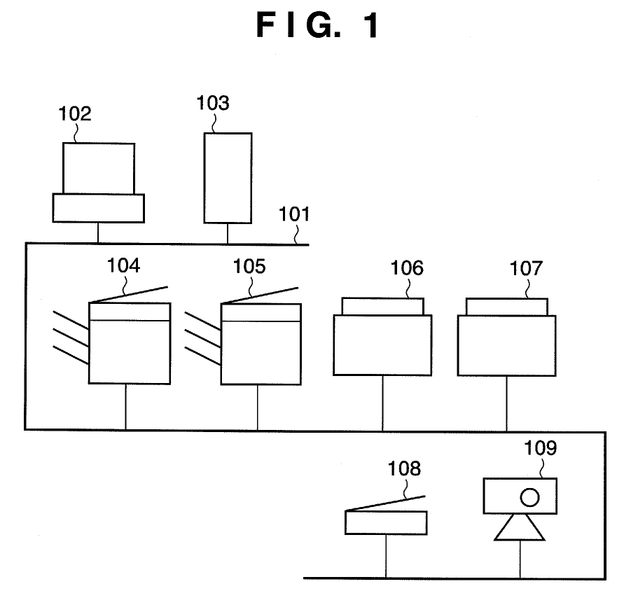

FIG. 1 is a diagram showing the arrangement of a device management system including that of connections between network devices and a computer according to the first embodiment of the present invention.

Referring to FIG. 1, reference numeral 101 denotes a local area network (LAN). Reference numeral 102 denotes a computer connected to the LAN 101. Reference numeral 103 denotes a server computer connected to the LAN 101.

Reference numerals 104 and 105 denote multi-functional peripheral equipments (devices having a plurality of types of functions such as a copy function, print function, scanner function, and the like; also called MFPs) connected to the LAN 101. Reference numerals 106 and 107 denote printers connected to the LAN 101. Also, various other devices (network devices) such as a network scanner 108, network camera 109, and the like are connected to the LAN 101.

Network device management of the first embodiment is implemented when a CPU executes software (to be referred to as device management software hereinafter) which runs on the computer 102. The device management software manages various devices 104 to 109 connected to the LAN 101. Also, in another mode, the device management software runs on the server computer 103, and is manipulated by a Web browser which runs on the computer 102, via an HTTP protocol. Note that a case will be exemplified below wherein the device management software runs on the computer 102.

Note that FIG. 1 shows the LAN 101 as the network, but the present invention is not limited to such specific network. The network may comprise any of the Internet, WAN, telephone line, dedicated digital line, ATM or frame relay line, communication satellite line, cable television line, data broadcasting wireless line, and the like in addition to the LAN. Also, the network may comprise a so-called communication network implemented by combining them, or it may adopt any other modes as long as devices can exchange data.

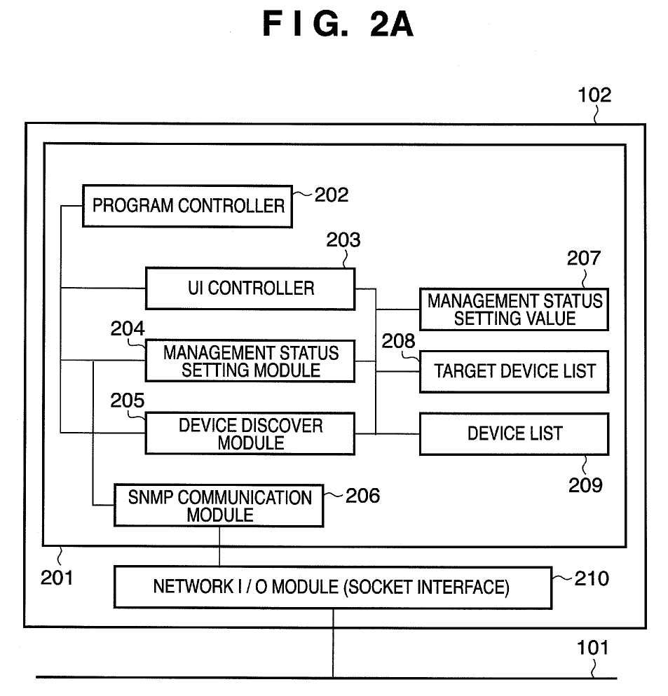

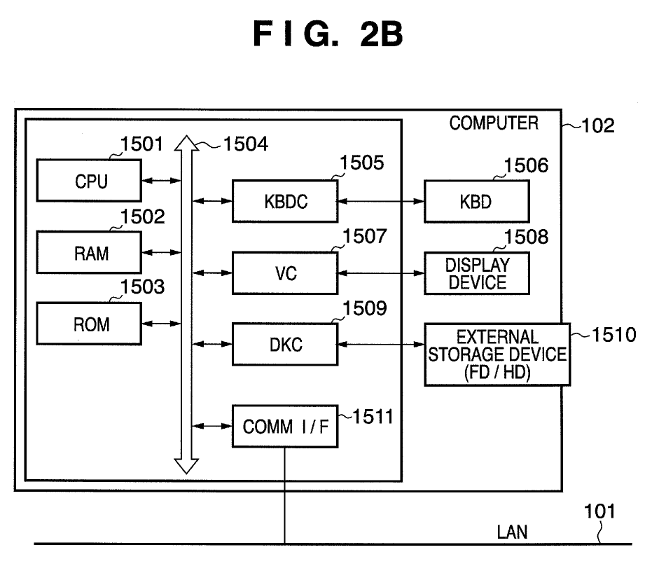

The functional arrangement implemented by the device management software will be described below with reference to FIG. 2A.

FIG. 2A is a block diagram showing the functional arrangement implemented by the device management software according to the first embodiment of the present invention.

In FIG. 2A, assume that an SNMP (Simple Network Management Protocol) is used in communications between the network devices and device management software 201. The SNMP is a protocol popularly used in network device management.

Referring to FIG. 2A, reference numeral 202 denotes a control unit which controls the overall program. Reference numeral 203 denotes a user interface (UI) controller which displays information for the user, and accepts data inputs from the user. The UI controller 203 is also used to select a target device, to set management statuses, and so forth.

Reference numeral 204 denotes a management status setting module used to write designated management statuses in a target device.

Reference numeral 205 denotes a device discover module used to discover devices connected to the LAN 101. The management status setting module 204 and device discover module 205 use the SNMP to communicate with the devices on the network. Reference numeral 206 denotes an SNMP communication module used to provide an SNMP communication function to upper modules.

Reference numeral 207 denotes a storage unit which holds setting values of management statuses (management status setting values) to be written in a target device. Reference numeral 208 denotes a storage unit which holds a list of target devices (target device list). Reference numeral 209 denotes a storage unit which holds a list of devices (device list) discovered by the device discover module 205. As these storage units, for example, a memory or files in the computer 102, tables in a database on the network, and the like can be used.

Reference numeral 210 denotes a network I/O module which is prepared by an operating system (OS) required to run the device management software 201. As the typical network I/O module 210, a socket interface is available.

The hardware arrangement of the computer 102 will be described below with reference to FIG. 2B.

FIG. 2B is a block diagram showing the hardware arrangement of the computer according to the first embodiment of the present invention.

Referring to FIG. 2B, the computer 102 comprises a CPU 1501, RAM 1502, ROM 1503, and external storage device 1510. The ROM 1503 or external storage device 1510 stores software such as an operating system, the device management software 201, and the like. The CPU 1501 executes software stored in the ROM 1503 or external storage device 1510 to systematically control respective devices connected to a system bus 1504.

The RAM 1502 serves as a main memory, work area, or the like of the CPU 1501. The external storage device 1510, comprises a hard disk (HD), floppy® disk (FD), and the like. The external storage device 1510 stores a boot program, operating system, various applications including the device management software, database data, font data, user files, and the like.

Furthermore, in the computer 102, reference numeral 1505 denotes a keyboard controller (KBDC), which transmits input information from a keyboard (KBD) 1506 or pointing device (not shown) to the CPU 1501. Reference numeral 1507 denotes a video controller (VC), which controls display on a display device 1508 comprising a CRT, LCD, or the like. Reference numeral 1509 denotes a disk controller (DKC), which controls accesses to the external storage device 1510. Reference numeral 1511 denotes a communication controller (COMM I/F), via which the computer 102 is connected to the LAN 101.

The SNMP will be briefly explained below. As described above, the SNMP is a standard protocol required to manage devices (network devices) connected to a network. The device management software 201 acquires management information from a network device and sets it in the network device using the SNMP. The management information is defined by an MIB (Management Information Base). With the SNMP, one packet stores a plurality of pieces of management information, and a plurality of pieces of management information can be acquired or set at the same time.

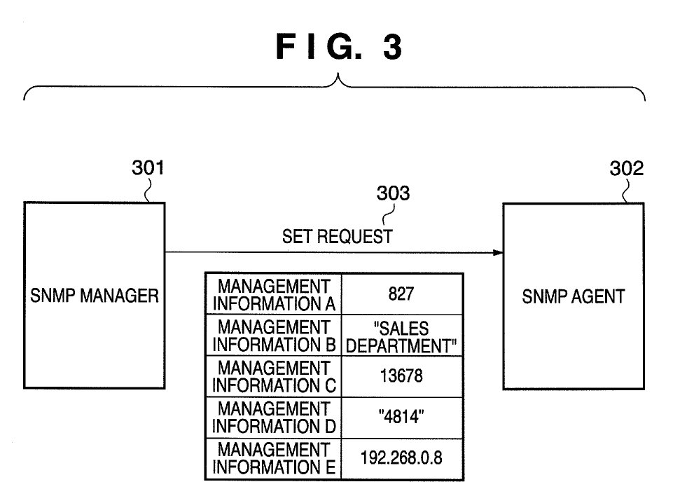

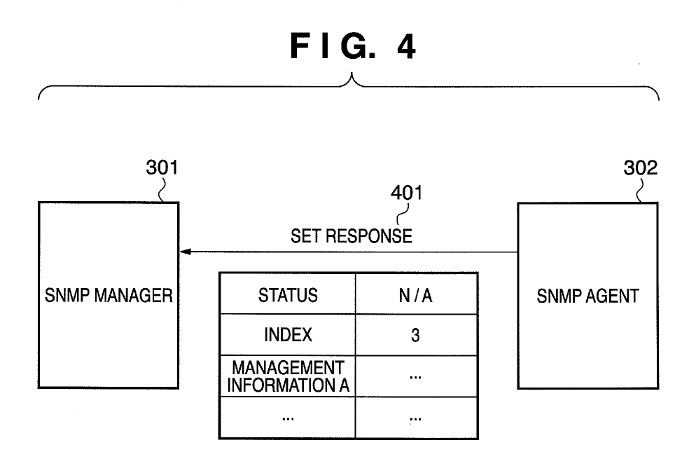

Examples of acquisition and setting of management information from and in a network device using the SNMP will be described below with reference to FIGS. 3 and 4.

FIGS. 3 and 4 are diagrams showing examples of acquisition and setting of management information from and in a network device using the SNMP according to the first embodiment of the present invention.

FIG. 3 shows a state in which an SNMP manager 301 transmits a SET request 303 to an SNMP agent 302. Note that the SNMP manager 301 is a module which makes device management using the SNMP. Also, the SNMP agent 302 is a module on the device side to be managed. FIG. 3 shows a case in which the SNMP manager 301 sets five pieces of management information (management information A to management information E) in the SNMP agent 302 using the SET request 303. Note that management information A and management information C are integers; B and D, character strings; and E, an IP address.

When the SNMP agent 302 implements all these pieces of management information and these pieces of management information are writable, the SNMP agent 302 executes a write process of these values on a self storage area, and returns a message indicating the success of the write process to the SNMP manager 301.

For example, assume that the SNMP agent 302 does not implement management information C, and management information E is read-only information. In this case, the SNMP agent 302 does not execute the requested write process at all, and returns a SET response 401 shown in FIG. 4 to the SNMP manager 301.

In the SET response 401 from the SNMP agent 302, an “index” row stores a number corresponding to management information in the SET request, which posed a problem first, and a “status” row stores the cause of the problem. If the SET request 303 from the SNMP manager 301 includes a plurality of problems, only information corresponding to the management information in the SET request, which posed a problem first, is included in the SET response 401. Therefore, when the SET request 303 has failed, the SNMP manager 301 cannot detect the number of problems included after the number indicated by the index in the SET response 401.

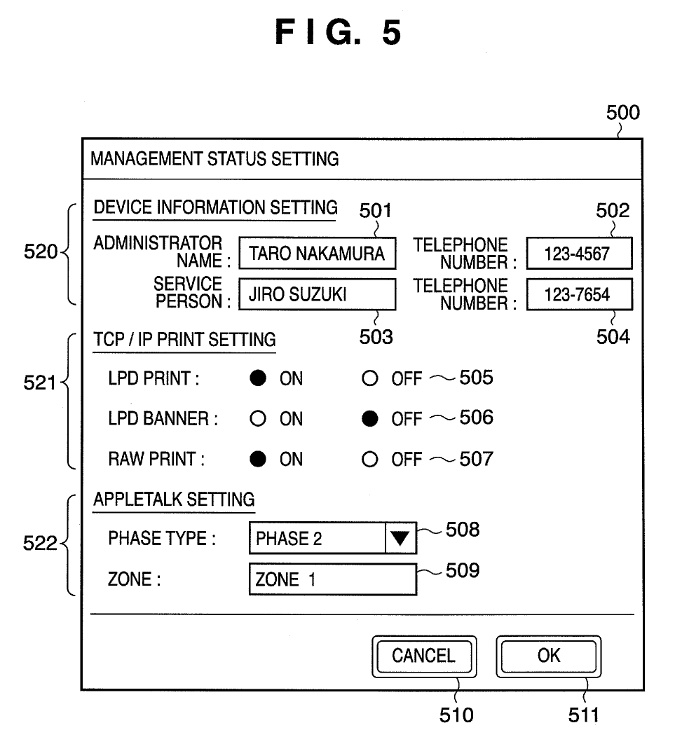

A management status setting window which allows the user to set setting values of management statuses to be written in a target device will be described below with reference to FIG. 5.

FIG. 5 shows a window example of the management status setting window according to the first embodiment of the present invention.

On a management status setting window 500, management statuses that can be set are roughly classified into setting items “device information setting” 520, “TCP/IP print setting” 521, and “AppleTalk setting” 522.

The “device information setting” item 520 has an administrator input field 501 of the target device, a telephone number input field 502 of the administrator, a service person input field 503, and a telephone number input field 504 of the service person.

The “TCP/IP print setting” item 521 has a radio button 505 used to designate ON/OFF of LPD printing by the target device, a radio button 506 used to designate the presence/absence of a banner upon LPD printing, and a radio button 507 used to designate ON/OFF of RAW printing.

The “AppleTalk setting” item 522 has a pull-down menu 508 used to select a phase type used, and a zone name input field 509.

The user can input and select information for respective setting items using the keyboard 1505 or pointing device.

If the user presses a “cancel” button 510, the setting process is canceled. On the other hand, if the user presses an “OK” button 511, the setting contents on the management status setting window 500 are settled, and are stored as, e.g., management status setting values 207. Note that a configuration that attaches a check box to the left side of each setting item and allows the user to select a management status to be written in the target device is also available.

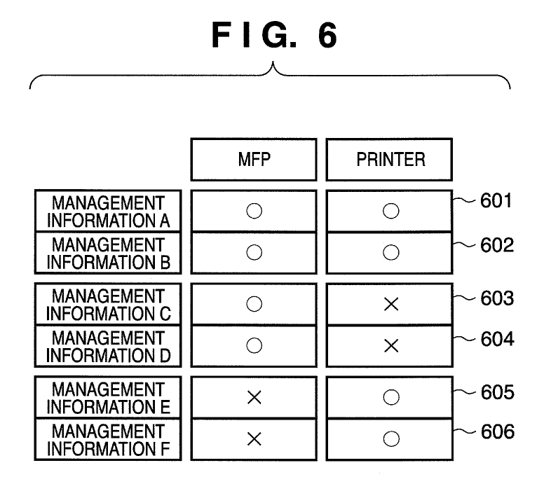

The implementation states of the set management statuses in correspondence with respective device types will be described below with reference to FIG. 6.

FIG. 6 shows the implementation states of the set management statuses in correspondence with respective device types according to the first embodiment of the present invention.

FIG. 6 uses expressions “management information A”, “management information B”, and the like in place of practical names such as “administrator name” and the like. In FIG. 6, “◯” indicates that the corresponding management status is implemented, and “x” indicates that it is not implemented. In FIG. 6, there are six pieces of management information A to F (information 601 to 606) as management information. These implementation states of the management information (management statuses) in correspondence with respective device types are stored in advance in the RAM 1502 of the computer 102.

Management information A and management information B are those which are common to all target devices. Management information C and management information D are management statuses that an MFP alone implements. Management information E and management information F are management statuses that a printer alone implements. When the device management software 201 sets management statuses using a single SET request of the SNMP, which combines all management status setting values of management information A to management information F, since this request includes management information that the MFP and printer do not implement, the SET request fails.

Hence, in the first embodiment, paying attention to the fact that the designated management status setting values can be classified into those which devices indispensably implement, and those which some devices do not implement, the management status setting values that all devices implement are set together using a single SET request. On the other hand, the management status setting values, the implementation states of which depend on devices, are set individually.

In other words, the set management status setting value group is classified into the management status setting values common to all target devices, and those which are common to each device type. Then, the management status setting values which belong to each class are simultaneously written (set) in a target device for that class.

The processing to be executed by the device management software 201 of the first embodiment will be described below.

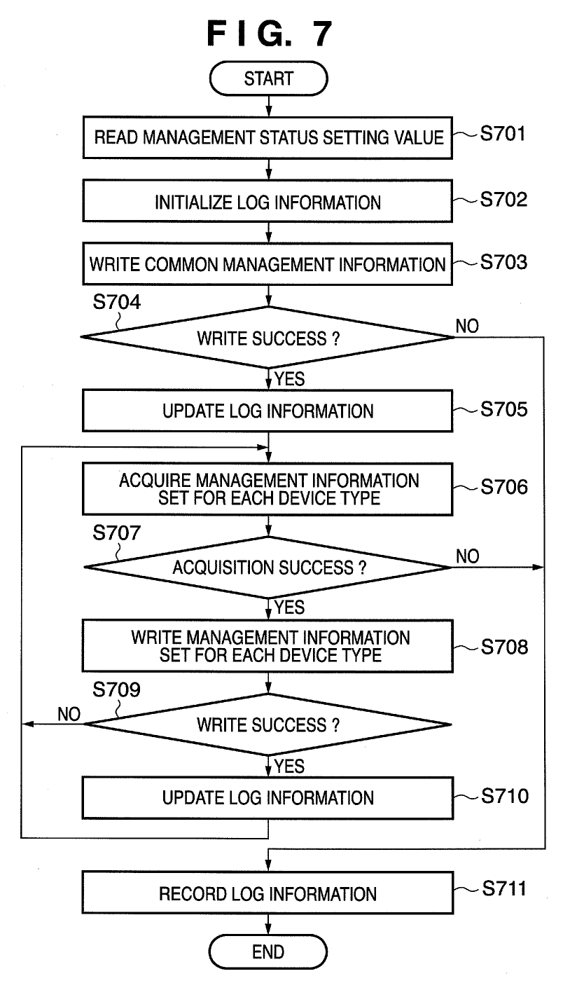

FIG. 7 is a flowchart showing the processing to be executed by the device management software according to the first embodiment.

Especially, FIG. 7 shows the processing executed when the device management software 201 writes set management status setting values in one target device. This processing is repetitively executed for all target devices.

In step S701, the device management software 201 reads, for example, the management status setting values set on the management status setting window shown in FIG. 5. In step S702, the software 201 initializes log information used to record a write log. Note that initial values of the log information are values indicating that the write processes of all the management status setting values have failed. If the write process of the management status setting value succeeds in the subsequent steps, the software 201 updates the log information by the setting value which is successfully written (steps S705 and S710). In last step S711 of the processing, the software 201 writes the log information in a storage device such as a database or the like together with the identifier of the target device.

The processes in step S703 and subsequent steps will be described below.

In step S703, the device management software 201 writes management information common to all target devices. The management information common to all the target devices includes, e.g., management information A and management information B in FIG. 6.

The device management software 201 checks in step S704 if the write process of the management information common to all the target devices has succeeded. If the write process of the management information common to all the target devices has failed (NO in step S704), the process jumps to step S711, and the software 201 records the log information with those contents, thus ending the processing for one target device.

On the other hand, if the write process of the management information common to all the target devices has succeeded (YES in step S704), the process advances to step S705 to update the log information by those contents.

After that, the device management software 201 repeats the write process of management information (step S708) for each device type in the subsequent process (S706). This process will be explained using the example of FIG. 6. That is, this means that the software 201 successively executes the write processes of a set of [management information C, management information D] and a set of [management information E, management information F] in step S708.

The processes in step S706 and subsequent steps will be described below.

In step S706, the device management software 201 sequentially acquires a management information set for each device type. The software 201 checks in step S707 if acquisition of the management information set for each device type has succeeded. If the acquisition has failed (NO in step S707), i.e., if no more management information set to be acquired remains, the process jumps to step S711 to record the log information by those contents, thus ending the processing for one target device.

On the other hand, if the acquisition of the management information set for each device type has succeeded (YES in step S707), the process advances to step S708 to write the acquired management information set in the target device. The device management software 201 checks in step S709 if that write process has succeeded. If the write process has failed (NO in step S709), the process returns to step S706 to acquire the next management information set for each target device type.

On the other hand, if the write process has succeeded (YES in step S709), the device management software 201 updates the log information by those contents in step S710, and the process returns to step S706 to acquire the next management information set for each target device type.

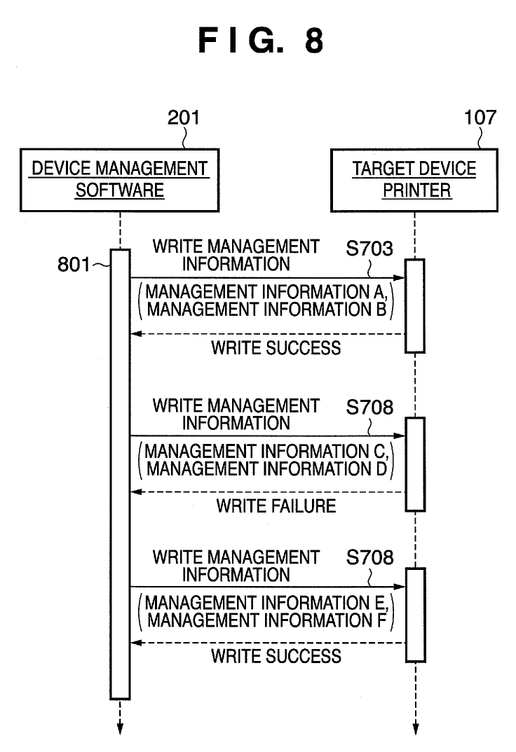

As a practical example, exchange of SNMP packets between the device management software 201 and a printer upon writing the management status setting values shown in FIG. 6 in the printer shown in FIG. 6 will be described below with reference to FIG. 8.

FIG. 8 is a chart for explaining exchange of SNMP packets upon setting the management status setting values between the device management software and printer according to the first embodiment of the present invention.

Assume that the printer 107 in FIG. 1 corresponds to that in FIG. 6.

Referring to FIG. 8, reference numeral 801 denotes the processes shown in the flowchart of FIG. 7. The device management software 201 writes the set of [management information A, management information B] as the management statuses common to all target devices in the printer 107 in step S703. Since the printer 107 implements these pieces of management information, the write process succeeds, and returns a message that advises accordingly to the device management software 201.

Next, the device management software 201 sequentially writes the management information for each device type. The software 201 writes a set of [management information C, management information D] common to the MFP first. However, since the printer 107 does not implement these pieces of management information, the write process fails. Then, the software 201 writes a set of [management information E, management information F] common to the printer 107. Since the printer 107 implements these pieces of management information, the write process succeeds.

As described above, according to the first embodiment, paying attention to the fact that the designated management status setting values can be classified into those which devices indispensably implement, and those which some devices do not implement, the management status setting values that all devices implement are set together using a single request. On the other hand, the management status setting values, the implementation states of which depend on devices, are set individually.

As a result, the processing efficiency associated with the setting processes can improve, thus reducing the network traffic.

### Second Embodiment

The arrangement of the second embodiment is basically the same as that of the first embodiment. Therefore, in the description of the second embodiment, the same reference numerals denote the same parts as in the arrangement of the first embodiment, a description of the first embodiment will be quoted, and only differences will be explained.

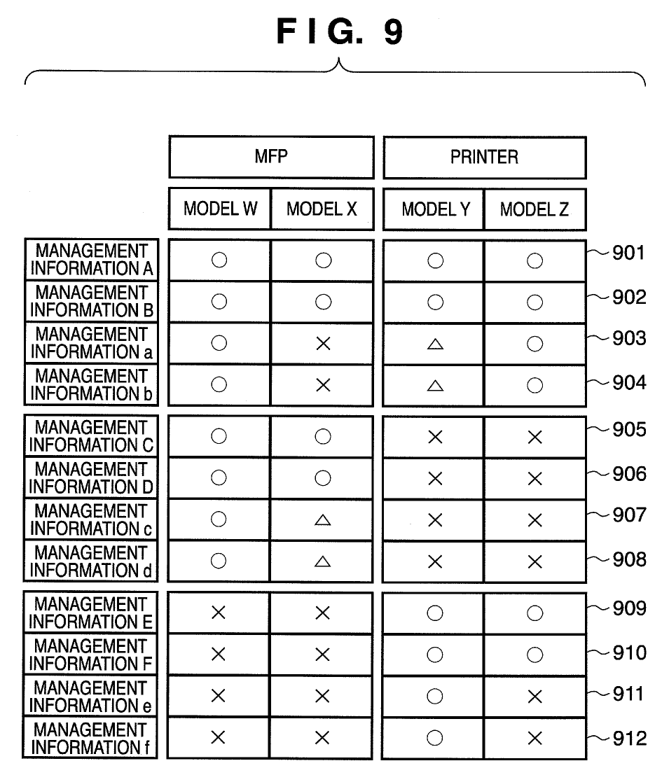

FIG. 9 shows the implementation states of set management statuses in correspondence with target devices according to the second embodiment of the present invention.

In FIG. 9, “◯” indicates that the corresponding management status is implemented, “x” indicates that it is not implemented, and “Δ” indicates that it is implemented as an option. In FIG. 9, 12 pieces of management information A to F (information 901 to 912) are available as management information.

Respective pieces of management information that target devices implement are classified into the following four types:

1. a management status group that all target devices commonly and indispensably implement;

2. a management status group that all target devices commonly implement as an option;

3. a management status group that target devices of a specific type commonly and indispensably implement; and

4. a management status group that target devices of a specific type commonly implement as an option.

As for each management status group, the management statuses in that management status group are implemented together. That is, when the management status group includes management statuses 1, 2, and 3, if a given device implements management status 1, it implements all of management statuses 2 and 3. Conversely, if a given device does not implement management status 1, it implements neither management status 2 nor management status 3. The option means a management status which is not implemented in the standard implementation state of a given device but is implemented if a certain option is added to that device.

In FIG. 9, a set of [management information A, management information B] is the management status group “1” that all target devices commonly and indispensably implement. Also, a set of [management information a, management information b] is the management status group “2” that all target devices commonly implement as an option.

A set of [management information C, management information D] and a set of [management information E, management information F] are the management status groups “3” that target devices of a specific type commonly and indispensably implement. A set of [management information c, management information d] and a set of [management information e, management information f] are the management status groups “4” that target devices of a specific type commonly implement as an option.

Under such situation, for example, when one of target devices is an MFP, the write process of the management information groups [management information E, management information F] and [management information e, management information f] that the printers commonly implement fails. Since [management information E, management information F] are management statuses indispensable to printers, [management information e, management information f] as an option are never implemented without implementing indispensable [management information E, management information F].

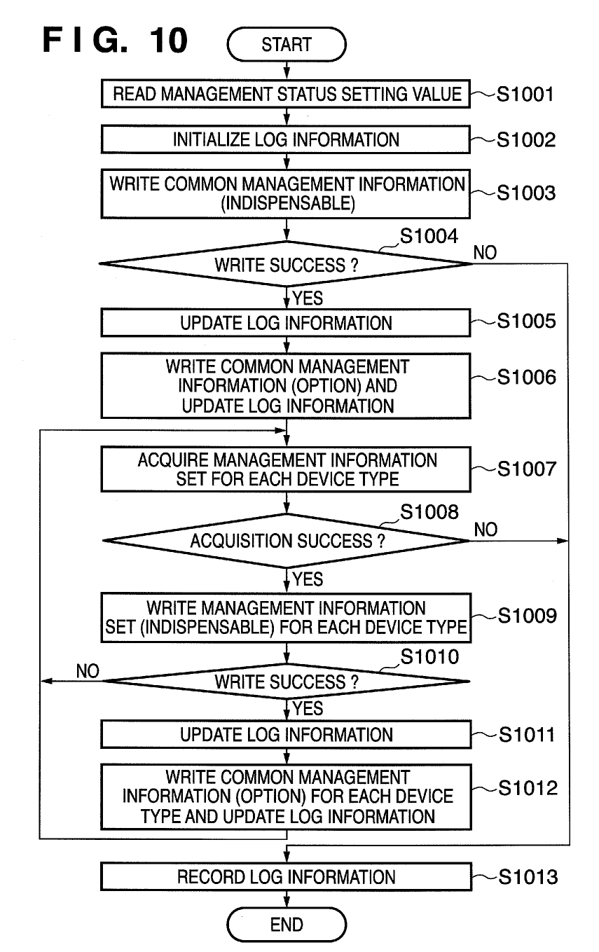

The processing to be executed by the device management software 201 of the second embodiment will be described below with reference to FIG. 10.

FIG. 10 is a flowchart showing the processing to be executed by the device management software according to the second embodiment of the present invention.

Especially, FIG. 10 shows the processing executed when the device management software 201 writes set management status setting values in one target device. This processing is repetitively executed for all target devices.

The basic processing sequence is the same as that in the flowchart in FIG. 7 of the first embodiment.

In step S1001, the device management software 201 reads, for example, the management status setting values set on the management status setting window shown in FIG. 5. In step S1002, the software 201 initializes log information used to record a write log. Note that initial values of the log information are values indicating that the write processes of all the management status setting values have failed. Especially, if the write process of the management status setting value succeeds in the subsequent steps, the software 201 updates the log information by the setting value which is successfully written (steps S1005, S1006, S1011, and S1012). In last step S1013 of the processing, the software 201 writes the log information in a storage device such as a database or the like together with the identifier of the target device.

The processes in step S1003 and subsequent steps will be described below.

In step S1003, the device management software 201 writes the management information group common and indispensable to all target devices. The management information group common and indispensable to all the target devices corresponds to, e.g., the set of [management information A, management information B] in FIG. 9.

The device management software 201 checks in step S1004 if the write process of the management information group common and indispensable to all the target devices has succeeded. If the write process of the management information group common and indispensable to all the target devices has failed (NO in step S1004), the process jumps to step S1013, and the software 201 records the log information with those contents, thus ending the processing for one target device.

On the other hand, if the write process of the management information group common and indispensable to all the target devices has succeeded (YES in step S1004), the process advances to step S1005 to update the log information by those contents. Subsequently, in step S1006 the device management software 201 writes the management information group common and optional to all the target devices and updates the log information. In case of FIG. 9, the management information group common and optional to all the target devices corresponds to the set of [management information a, management information b]. The software 201 executes this step S1006 only when the management information group as an option is available.

Subsequently, the device management software 201 repeats the write process of management information (steps S1009 and S1012) for each device type in the subsequent process (S1007). This process will be explained using the example of FIG. 9. That is, this means that the software 201 successively executes the write processes of management statuses for the MFPs and printers in steps S1009 and S1012.

The processes in step S1007 and subsequent steps will be described below.

In step S1007, the device management software 201 sequentially acquires management information groups for each device type. In this case, the software 201 acquires the indispensable and optional management information groups for the type of the target device together. The software 201 checks in step S1008 if acquisition of the management information group for each device type has succeeded. If the acquisition has failed (NO in step S1008), i.e., if no more management information group to be acquired remains, the process jumps to step S1013 to record the log information by those contents, thus ending the processing for one target device.

On the other hand, if the acquisition of the management information group for each device type has succeeded (YES in step S1008), the process advances to step S1009 to write the indispensable management information group of the acquired management information groups in the target device. The device management software 201 checks in step S1010 if that write process has succeeded. If the write process has failed (NO in step S1010), the process returns to step S1007 to acquire the next management information group for each target device type.

On the other hand, if the write process has succeeded (YES in step S1010), the device management software 201 updates the log information by those contents in step S1011. In step S1012, the software 201 writes the optional management information group in the target device and updates the log information. The software 201 executes this step S1012 only when the optional management information group is available. After completion of the write process of the optional management information group, the process returns to step S1007 to acquire the next management information set for each target device type.

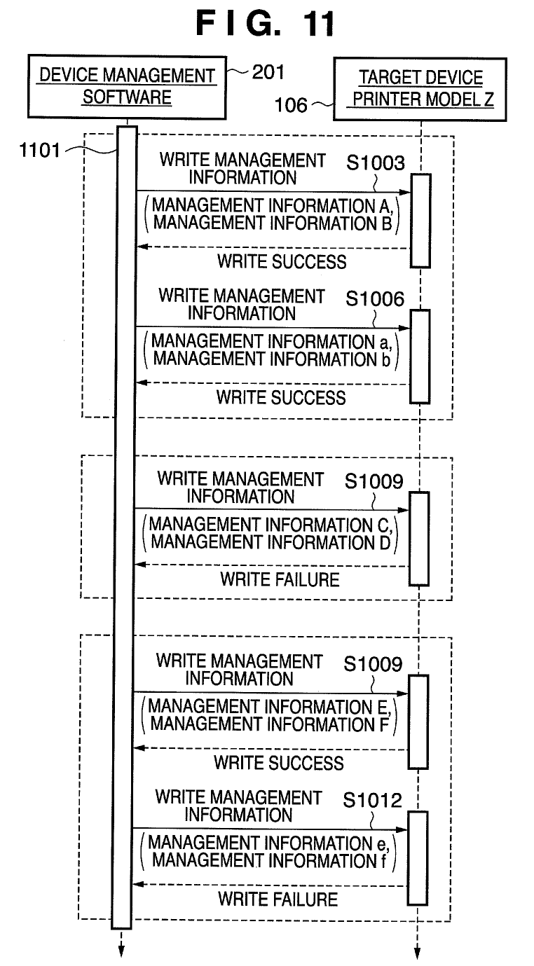

As a practical example, exchange of SNMP packets between the device management software 201 and printer upon writing the management status setting values shown in FIG. 9 in the printer shown in FIG. 9 will be described below with reference to FIG. 11.

FIG. 11 is a chart for explaining exchange of SNMP packets upon setting the management status setting values between the device management software and printer according to the second embodiment of the present invention.

Especially, FIG. 11 shows exchanges of SNMP packets between the device management software 201 and printer upon writing management status setting values in a printer of model Z shown in FIG. 9. Assume that the printer 106 in FIG. 1 corresponds to the printer of model Z in FIG. 9.

Referring to FIG. 11, reference numeral 1101 denotes the processes shown in the flowchart of FIG. 10. The device management software 201 writes the set of [management information A, management information B] as the management statuses common and indispensable to all target devices in the printer 106 in step S1003. Since the printer 106 implements these pieces of management information, the write process succeeds, and the printer 106 returns a message that advises accordingly to the device management software 201.

Next, the device management software 201 writes [management information a, management information b] as management statuses common and optional to all the target devices in step S1005. Since the printer 106 implements these pieces of management information, the write process succeeds, and the printer 106 returns a message that advises accordingly to the device management software 201.

Subsequently, the device management software 201 sequentially writes the management information for each device type. The software 201 writes a set of [management information C, management information D] common and indispensable to the MFP first. However, since the printer 106 does not implement these pieces of management information, the write process fails. Therefore, the software 201 skips the write process of a set of [management information c, management information d] as management statuses common and optional to the MFP.

Then, the device management software 201 writes a set of [management information E, management information F] as management statuses common and indispensable to the printer 106. Since the printer 106 implements these pieces of management information, the write process succeeds. Since the write process of the management statuses common and indispensable to the printer has succeeded, the device management software 201 subsequently executes the write process of management statuses common and optional to the printer. Since the printer 106 does not implement these optional management statuses, the write process fails.

As described above, according to the second embodiment, even for setting values, whose implementation states depend on devices, a set of setting values, which is indispensably implemented as a set (for example, when setting value A1 is implemented, A2 and A3 are indispensably implemented) is set together. In this way, the processing efficiency associated with the setting processes can improve, thus reducing the network traffic.

### Third Embodiment

The arrangement of the third embodiment is basically the same as that of the second embodiment. Therefore, in the description of the third embodiment, the same reference numerals denote the same parts as in the arrangement of the second embodiment, a description of the second embodiment will be quoted, and only differences will be explained.

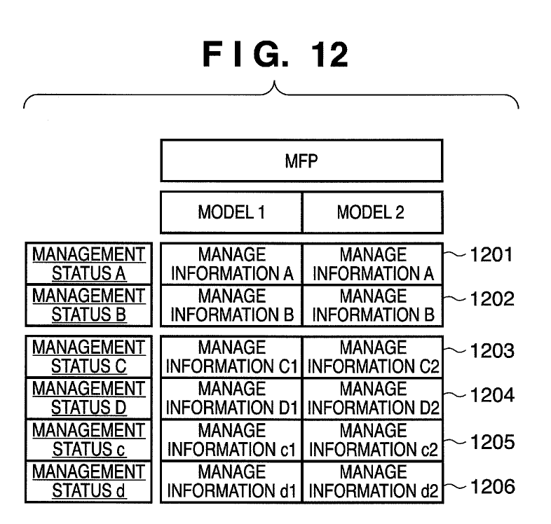

FIG. 12 shows the implementation states of set management statuses in correspondence with target devices according to the third embodiment of the present invention.

FIG. 12 shows a state in which different management information is assigned to an identical management status depending on the models of devices. For example, management status A (status 1201) and management status B (status 1202) correspond to common management information for both models 1 and 2. However, as for management status C (status 1203) to management status d (status 1206), different management status setting values are used for models 1 and 2 upon acquiring and writing these management statuses.

When an identical management status has different pieces of management information for respective models, if the write process of management information for one model has succeeded, the write process of management information for another model need not be executed.

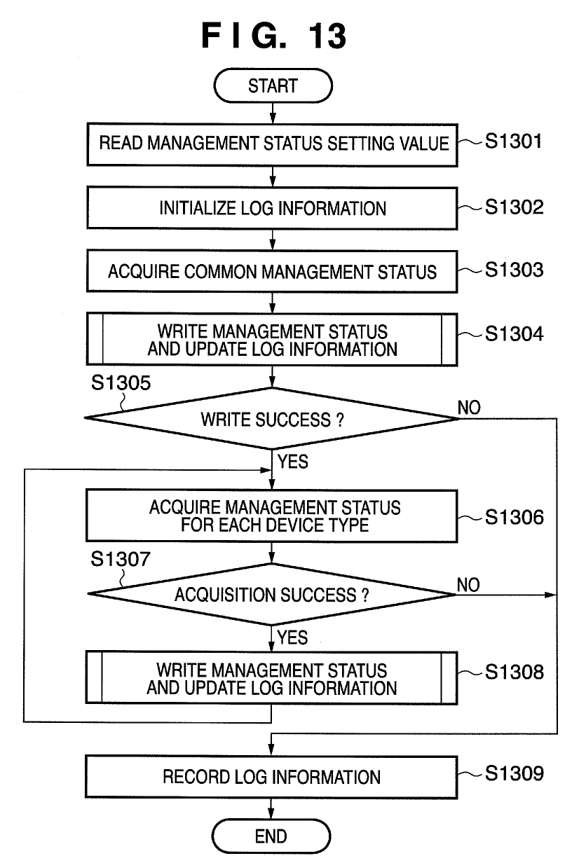

The processing to be executed by the device management software 201 of the third embodiment will be described below with reference to FIG. 13.

FIG. 13 is a flowchart showing the processing to be executed by the device management software according to the third embodiment of the present invention.

Especially, FIG. 13 shows the processing executed when the device management software 201 writes set management status setting values in one target device. This processing is repetitively executed for all target devices.

The basic processing sequence is the same as that in the flowchart in FIG. 7 of the first embodiment.

In step S1301, the device management software 201 reads, for example, the management status setting values set on the management status setting window shown in FIG. 5. In step S1302, the software 201 initializes log information used to record a write log. Note that initial values of the log information are values indicating that the write processes of all the management status setting values have failed. Especially, if the write process of the management status setting value succeeds in the subsequent steps, the software 201 updates the log information by the setting value which is successfully written (steps S1304 and S1308). In last step S1309 of the processing, the software 201 writes the log information in a storage device such as a database or the like together with the identifier of the target device.

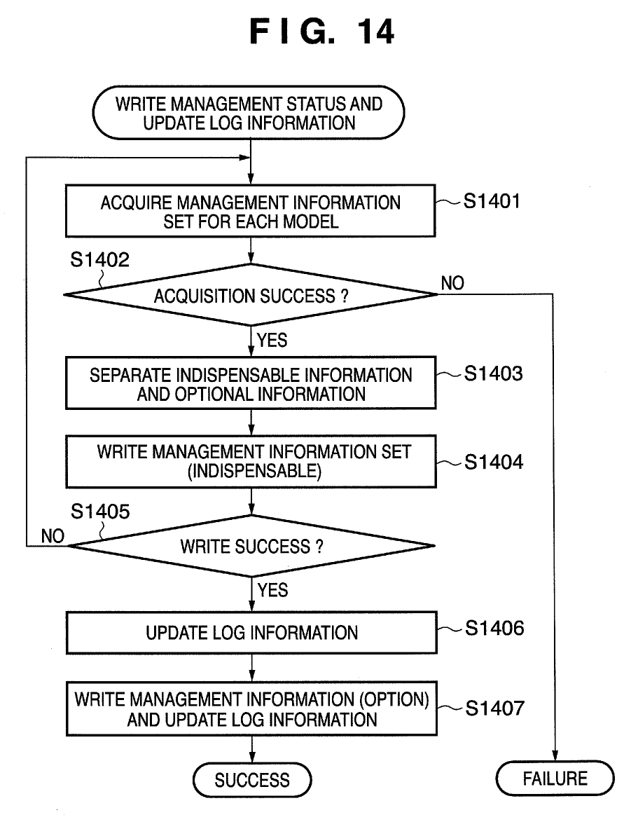

In step S1303, the device management software 201 acquires management statuses common to all target devices. In step S1304, the software 201 calls and executes “write management status and update log information” processing. Details of this processing will be described later with reference to FIG. 14.

The device management software 201 checks in step S1305 if the write process in step S1304 has succeeded. If the write process has failed (NO in step S1305), the process jumps to step S1309, and the software 201 records the log information with those contents, thus ending the processing for one target device.

On the other hand, if the write process has succeeded (YES in step S1305), the device management software 201 subsequently repeats the write process of management statuses for each device type (especially, for each model in this case) (step S1308) in the subsequent process (step S1306).

In step S1306, the device management software 201 sequentially acquires management statuses for each device type. The software 201 checks in step S1307 if acquisition of the management statuses for each device type has succeeded. If the acquisition has failed (NO in step S1307), i.e., if no more management statuses to be acquired remain, the process jumps to step S1309 to record the log information by those contents, thus ending the processing for one target device.

On the other hand, if the acquisition of the management statuses for each device type has succeeded (YES in step S1307), the device management software executes “write management status and update log information” processing in step S1308. Details of this processing will be described later with reference to FIG. 14. After completion of the write process of management statuses for each device type, the process returns to step S1306 to acquire the next management information group for each target device type.

Details of the processing in steps S1304 and S1307 in FIG. 13 will be described below with reference to FIG. 14.

FIG. 14 is a flowchart showing details of the processing in steps S1304 and S1307 according to the third embodiment of the present invention.

Note that this processing is to be applied to the management statuses acquired in step S1303 or S1306 in FIG. 13. For example, these management statuses correspond to a set of management statuses, e.g., [management status C, management status D, management status c, management status d] in FIG. 12. In step S1401, the device management software 201 sequentially acquires management information sets for each model. This means that the software 201 sequentially acquires [management information C1, management information D1, management information c1, management information d1] and [management information C2, management information D2, management information c2, management information d2] in the example of FIG. 12.

The device management software 201 checks in step S1402 if acquisition of the management information sets for each model has succeeded. If the acquisition has failed (NO in step S1402), i.e., if the sequential acquisition of the management information sets is complete, the software 201 returns “failure” to a call source of the processing. On the other hand, if the acquisition has succeeded (YES in step S1402), the process advances to step S1403.

Note that the following processes will be described under the assumption that the device management software 201 has acquired the first management information set [management information C1, management information D1, management information c1, management information d1]. Even when the software 201 has acquired the next management information set [management information C2, management information D2, management information c2, management information d2], the basic processing sequence is the same.

In step S1403, the device management software 201 separates the acquired management information set into an indispensable management information set ([management information C1, management information D1]) and optional management information set ([management information c1, management information d1]).

In step S1404, the device management software 201 writes the indispensable management information set. The software 201 checks in step S1405 if the write process has succeeded. If the write process has failed (NO in step S1405), the process returns to step S1401 to acquire the next management information set for each model.

On the other hand, if the write process has succeeded (YES in step S1405), the process advances to step S1406 to update the log information by those contents. In step S1407, the device management software 201 writes the optional management information set and updates the log information, and returns “success” to the call source of the processing.

As described above, according to the third embodiment, upon writing (setting) setting values in a target device, an attempt is made to execute a process for setting all designated setting values irrespective of implemented setting values of devices, thus obviating the need for model dependent processes. In this way, when a new device is to be coped with, the management load on the administrator upon changing management statuses can be reduced.

### Other Embodiments

In each of the aforementioned embodiments, a target device may notify the management terminal as a write source of a message of the processing result including success/failure of the write process in that target device. This message includes, e.g., a dedicated dialog, e-mail, and the like.

On the other hand, the management terminal can output the management status setting values, which include the ON/OFF settings of target devices and are actually set, in the form of a table by merging the processing results returned from the respective target devices. In this way, the administrator can easily recognize the setting states of the management status setting values in the target devices.

Causes of the write failure of the management status setting values in a target device include troubles that have occurred on the network itself in addition to those depending on the target device. In such case, if the write process succeeds within a predetermined number of times while expecting removal of such troubles, that write process may be attempted a plurality of number of times.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-283145 filed on Oct. 17, 2006, which is hereby incorporated by reference herein in its entirety.

What is claimed is:

1. An information management apparatus, which sets management statuses of a plurality of devices connected to a network, and writes the management statuses in a target device, comprising:
setting means for setting management statuses of a device;
storage means for classifying a management information group set by the management statuses set by said setting means into management information common to the plurality of target devices and management information common to each type of target device, and storing the classified management information; and
writing means for executing a write process of the management information, which belongs to each of classes stored in said storage means, in the target device.

2. The apparatus according to claim 1, further comprising management status storage means for storing management statuses for each of the plurality of devices,
wherein said storage means classifies, with reference to the management statuses stored in said management status storage means, the management information group set by the management statuses set by said setting means into the management information common to the plurality of target devices and the management information common to the type of target device, and stores the classified management information.

3. The apparatus according to claim 1, further comprising determination means for determining whether or not the write process by said writing means has succeeded; and
log information storage means for storing the determination result of said determination means as log information.

4. The apparatus according to claim 1, wherein said writing means executes a write process of the management information common to the plurality of target devices of classes stored in said storage means, and then executes a write process of the management information common to each device type.

5. The apparatus according to claim 1, wherein said writing means executes a write process of the management information in the target device using an SNMP.

6. The apparatus according to claim 1, wherein said storage means classifies the management information group set by the management statuses set by said setting means into:
first indispensable management information that the plurality of target devices commonly and indispensably implement;
first optional management information that the plurality of target devices commonly and optionally implement;
second indispensable management information that a plurality of target devices of a specific type commonly and indispensably implement; and
second optional management information that the plurality of target devices of the specific type commonly and indispensably implement and
the storing means stores the classified management information.

7. The apparatus according to claim 6, wherein said writing means executes a write process of corresponding optional information in the target device when a write process of the indispensable management information of the classes stored in said storage means in the target device has succeeded.

8. The apparatus according to claim 1, wherein when said storage means assigns different management information to an identical management status depending on types of devices, and when a write process of management information corresponding to a device of an arbitrary type has failed, said writing means executes a write process of management information corresponding to a target device of a type different from that type in the target device.

9. A method of controlling an information management apparatus, which sets management statuses of a plurality of devices connected to a network, and writes the management statuses in a target device, comprising:
a setting step of setting management statuses of a device;
a storage step of classifying a management information group set by the management statuses set in said setting step into management information common to the plurality of target devices and management information common to each type of target device, and storing the classified management information in a storage medium; and
a writing step of executing a write process of the management information, which belongs to each of classes stored in the storage medium in the storage step, in the target device.

10. A program stored in a computer-readable medium to make a computer execute control of an information management apparatus, which sets management statuses of a plurality of devices connected to a network, and writes the management statuses in a target device, the program making the computer execute:
a setting step of setting management statuses of a device;
a storage step of classifying a management information group set by the management statuses set in said setting step into management information common to the plurality of target devices and management information common to each type of target device, and storing the classified management information in a storage medium; and
a writing step of executing a write process of the management information, which belongs to each of classes stored in the storage medium in the storage step, in the target device.

11. An information management apparatus, which sets management statuses of a plurality of devices connected to a network, and writes the management statuses in a target device, comprising:
storage means for classifying a management information group into management information commonly used in the plurality types of target devices and management information commonly used in each type of target device, wherein storing the classified management information as classes; and
writing means for executing, by using a request for setting a plurality of information compliant with SNMP, a write process of the management information, which belongs to each of classes stored in said storage means, in the target device
wherein the writing process is executed by each class.

12. An information processing method for controlling an information management apparatus, which sets management statuses of a plurality of devices connected to a network, and writes the management statuses in a target device, comprising:
a classification step of classifying a management information group into management information commonly used in the plurality types of target devices and management information commonly used in each type of target device, wherein storing the classified management information as classes; and
an execution step of executing, by using a request for setting a plurality of information compliant with SNMP, a write process of the management information, which belongs to each of the classes classified, in the target device wherein the writing process is executed by each class.

13. A computer program stored in a computer-readable medium to make a computer execute control of an information management apparatus for executing the information processing method of claim 12.
